(19) United States
(12) Patent Application Publication
(10) Pub. No.: US 2002/0027846 A1
(43) Pub. Date: Mar. 7, 2002

(54) Information carrier, apparatus for retrieving information from the information carrier and apparatus for recording information on the information carrier

(75) Inventors: Aalbert Stek, Eindhoven (NL); Roel Van Woudenberg, Eindhoven (NL)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/944,305

(22) Filed: Aug. 31, 2001

(30) Foreign Application Priority Data
Sep. 5, 2000 (EP) 00203053.4

(51) Int. Cl. G11B 7/24

(52) U.S. Cl. 369/47.35; 369/275.3

(57) ABSTRACT

The invention relates to an additional information field DI in at least a group of headers 3 on an information carrier. The additional information field may be used to store information describing properties of the information carrier. This information can be stored in an information field DI of a single header or, alternatively, in the information fields DI of a sub-group of headers 3. When no information field DI is present in a second group of headers, a second synchronization field VFO2 may replace the information field DI.

The invention relates to an information carrier comprising an information area for recording data encoded in marks, said information area comprising tracks provided with a servopattern comprising headers alternating with track portions, which headers comprise a synchronization field comprising marks representing a predetermined synchronization pattern for synchronizing a clock frequency in a device the information carrier is used in, a first identification field comprising marks representing position information and subsequently a second identification field comprising marks representing position information.

The invention also relates to a reading device for reading data from the information carrier, which reading device comprises reading means for retrieving data from the information carrier, and to a recording device for recording data on the information carrier, which recording device comprises reading means for retrieving data from the information carrier and recording means for recording data on the information carrier.

Within the scope of this application marks are considered to include all detectable regions on an information carrier such as for example amorphous regions within a crystalline surrounding on an optical information carrier of the phase change type or pits on an optical information carrier comprising embossed data. However, marks are not limited to optically detectable regions but alternatively magnetically or magneto-optically detectable regions may be used.

An information carrier according to the preamble is know from the European Computer Manufacturers Association Standards ECMA-153 and ECMA-154. Such an information carrier is also described in the Handbook of Magneto-Optical Data Recording; McDaniel, TW and Victora, RH; Noyes Publications; 1977. On the known information carrier data is recorded in tracks, a track being formed by a 360 degree turn of a continuous spiral. Each track is subdivided in the longitudinal direction into a number of segments, each segment starting with a header. The data is recorded in the segment areas between the headers. The headers comprise patterns representing header information. This header information is used in a reading device and in a recording device to correctly assess or record data on the information carrier. In general the headers are made during manufacture, for example, in the form of so-called pre-pits formed by embossing.

Each header comprises a synchronization area, a so-called VFO field, for synchronizing a clock in the reading device and in the recording device the information carrier is used in. Such a clock is, for example, generated by Variable Frequency Oscillator (VFO) circuitry located in the devices. This VFO field, consisting of a predetermined pattern of marks, is used to “lockup”, that is, establish the proper frequency and phase of the read/write channel clock of the device when the header is read. More specifically, the VFO field establishes the write channel clock frequency and phase when a segment is being written and it establishes the read channel clock frequency and phase when a segment is being read. In general this “lockup” is realized by Phase Lock Loop (PLL) circuitry which relates the read/write channel clock to a signal obtained from reading the synchronization pattern in the VFO field. The VFO field is also used to settle the slicer level of circuitry which converts an analog High Frequency (HF) signal obtained from reading the patterns of marks and spaces representing the information into a digital information signal. Furthermore, the VFO field is used to set the dynamic range of an Automatic Gain Controlled (AGC) amplifier which amplifier ensures that the full range of an analog-to-digital conversion circuitry is utilized.

Each header further comprises an identification field, a so-called ID field, comprising position information. This ID field comprises pre-recorded address marks representing the address of a segment, that is the track number and the segment number of the segment. The address marks representing the position information may be used for positioning a recording head in a recording device on a desired track and are indicative for the address of the segment area following the header. The position information in the headers is especially useful when no other data is recorded in the information area because it is then the only way to determine the location of a reading spot on the information carrier.

In order to ensure a correct readout of the identification field in the header it is preceded by the synchronization area. This ensures that the circuitry of the reading means is set such that the address marks in the identification field can be read correctly.

To further prevent erroneous retrieval of the position information from a header, each header comprises at least two identification fields. These two identification fields are spatially separated. Because of this, local deterioration of an information carrier, for example caused by fingerprints or dust, may corrupt a first identification field while the second remains readable. Each identification field in a single header contains an identical address. However, because of a cyclic redundancy check (CRC) code word that extends across the identification field and because of a number indicating whether the specific identification field is the first or the second ID field, the pattern of marks encoding the address in the first identification field may differ from the pattern of marks encoding the address in the second identification field.

It is a problem of the known information carrier that the headers are only capable of containing a limited amount of information. This is especially a problem when the headers are the only areas on an information carrier capable of holding pre-recorded information in the form of, for example, embossed pits.

It is inter alia an object of the invention to provide an information carrier which allows for the storage of pre-recorded additional information in the headers.

For this purpose an information carrier as described in the opening paragraph is characterized according to the invention in that the headers in at least a group of headers also comprise an information field located in between the first identification field and the second identification field, said information field comprising marks representing information. This has the effect that additional information is available in the headers.

In the known information carrier each identification field in a header is preceded by a synchronization area. Because of this, the circuitry of the reading means is set before reading each of the identification fields in a single header. The invention is based on the understanding that setting the circuitry of the reading means before reading each of the identification fields is unnecessary when the successive identification fields are located close to each other as is the case in headers of an information carrier. Therefore, it is sufficient to have just a single synchronization area before the first identification field in a header and have the other identification fields replaced by information fields. In this way, space becomes available for storing additional information.

An embodiment of the information carrier according to the invention is characterized in that the information field comprises marks representing information describing properties of the information carrier. It is especially useful when the space which becomes available for storing additional information is used for storing information describing properties of the information carrier. When the information carrier is inserted into a reading device or into a recording device header information together with the information describing properties of the information carrier can be retrieved and on the basis of this information the reading means or the recording means in the devices can be set in such a way that they are adapted for the specific information carrier.

Examples of information describing properties of the information carrier which may be stored in the information fields in the headers of the information carrier are inter alia the number of recording layers, the type of the recording layers, the read power, the write power, the ratio of the erase power to the write power, the ratio of the bias power to the write power, parameters used in an Optimum Power Control (OPC) procedure in a recording device, and parameters describing the shape of a sequence of write pulses generated by a recording device to record data on the information carrier.

A further embodiment of the information carrier according to the invention is characterized in that the headers in a second group of headers also comprise a second synchronization field located in between the first identification field and the second identification field, said second synchronization field comprising marks representing a predetermined synchronization pattern for synchronizing a clock frequency in a device the information carrier is used in. Information fields may be present in all headers of an information carrier or, alternatively, just in a group of headers. In the headers not comprising an information field, synchronization fields are located just before the identification fields comprising marks representing position information.

When, for example, an information area comprises successively a lead-in zone comprising marks representing control information, a data zone intended for recording user data, and a lead-out zone comprising marks representing control information, the headers in the lead-in zone and in the lead-out zone may comprise information fields while the headers in the data zone may comprise second synchronization fields.

An embodiment of the information carrier according to the invention is characterized in that the information is distributed over a sub-group of headers. When a large amount of information has to be stored in the information fields of the headers, this information is divided into parts and the parts are recorded in the information fields of various headers. Before the information can be retrieved from the information carrier, all parts have to be read from the various information fields.

A further embodiment of the information carrier according to the invention is characterized in that the information is distributed over a predetermined number of consecutive headers. In this way the information can be retrieved from the headers very easily and very quickly because no jumps of the reading spot the in radial direction are required.

To protect the distributed information recorded in the information fields from erroneous retrieval, this information may be protected by an error correction code. This error correction code is to be applied to all information in the information fields of the predetermined number of headers.

Further objects of the invention are to provide a reading device and a recording device capable of retrieving the additional information from the information carrier according to the invention.

This object is achieved by providing a reading device as described in the opening paragraph which is characterized according to the invention in that the reading means are arranged for retrieving information describing properties of the information carrier from an information field located in between the first identification field and the second identification field in the headers, and in that the reading means are set in dependence on the retrieved information describing properties of the information carrier.

This object is also achieved by providing a recording device as described in the opening paragraph characterized according to the invention in that the reading means are arranged for retrieving information describing properties of the information carrier from an information field located in between the first identification field and the second identification field in the headers, and in that the recording means are set in dependence on the retrieved information describing properties of the information carrier.

These and other objects, features and advantages of the invention will be apparent from and elucidated further with reference to the embodiments of the invention described by way of example in the following description and with reference to the accompanying drawings where

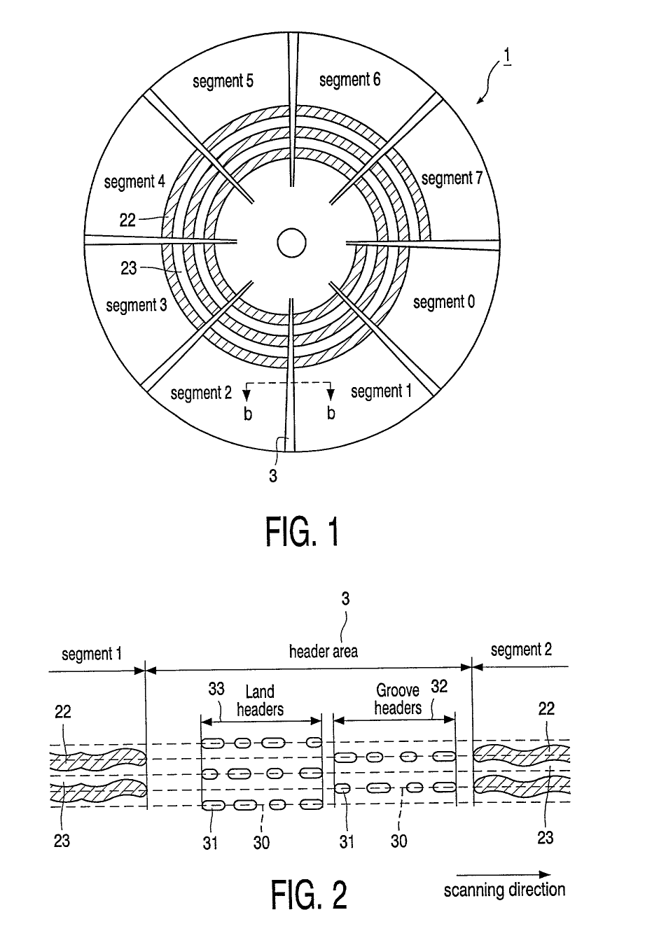

FIG. 1 shows an information carrier according to a first embodiment of the invention,

FIG. 2 diagrammatically shows a header,

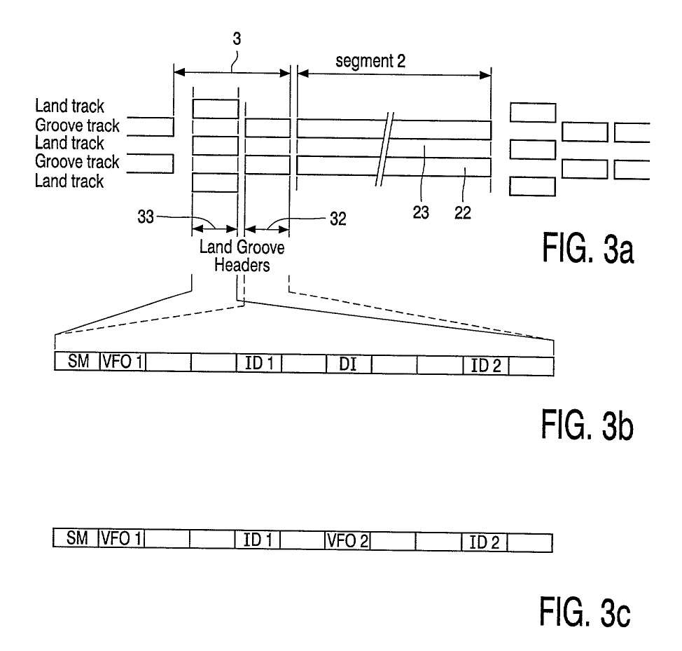

FIG. 3 shows a schematic layout of a header according to an embodiment of the invention,

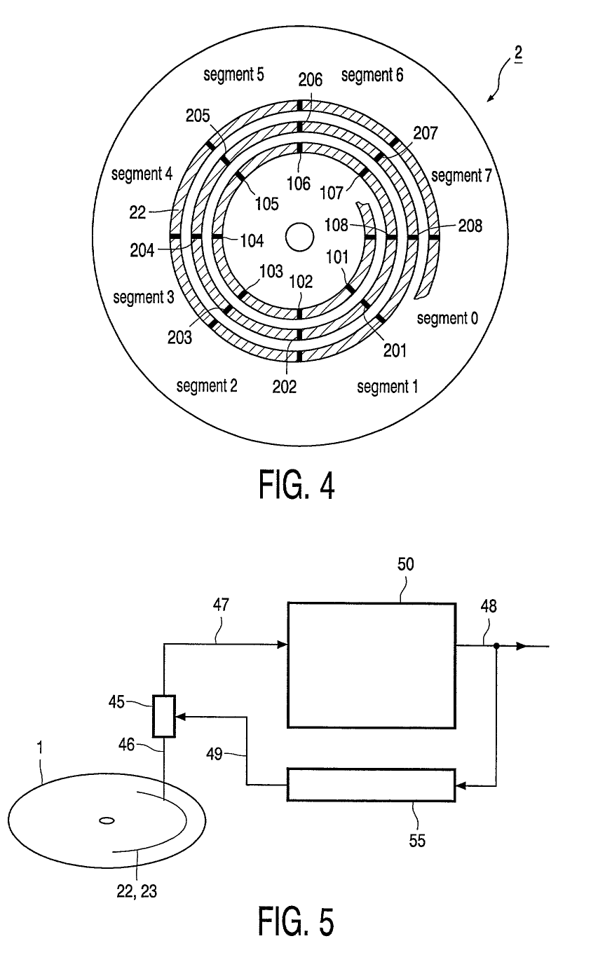

FIG. 4 shows an information carrier according to a second embodiment of the invention, and

FIG. 5 shows an embodiment of a reading device according to the invention.

FIG. 1 shows a disc-shaped information carrier 1 of an optically readable type according to a first embodiment of the invention. On this information carrier 1 tracks are formed by a single spiral groove, the Groove track 22, from the inside of the information carrier towards the outside of the information carrier and by a single spiral, the Land track 23, in between neighboring grooves. Each track is divided into 8 segments numbered segment0 to segment7. Each segment starts with a header area 3 comprising patterns of embossed pits and of spaces between the pits which represent header information. Data may be recorded in both the Groove track 22 portions and the Land track 23 portions in between the header areas 3.

FIG. 2 shows a section along line b-b of the information carrier 1. A header area 3 is located in between segment1 and segment2. Segement1 and segment2 each comprise Groove tracks 22 and Land tracks 23. The header area 3 comprises Groove headers 32 related to the Groove tracks 22 and Land headers 33 related to the Land tracks 23. When the information carrier 1 is read, the Land headers 33 appear earlier in time than the Groove headers 32. The Groove headers 32 and the Land headers 33 comprise header information which is represented by a patterns of marks 31 in the form of embossed pits and of spaces 30 between the marks.

FIG. 3 shows a schematic layout of a Groove header 32 or a Land header 33 within the header area 3. Each header consists of a number of fields 39, having a fixed total storage capacity of, for example, 1080 channel bits, as is schematically shown in FIG. 3b. A Sector Mark field, SM, is generally located at the beginning of a header. This SM field contains a unique pattern allowing it to be easily found and thus unambiguously indicate the beginning of a header and hence of a segment.

A header comprises a VFO field, VFO1, and two ID fields, ID1 and ID2. The VFO field is used to “lockup”, i.e., establish the proper frequency and phase of the read/write channel clock of the device when the header is read. The VFO fields are also used to settle the slicer level of circuitry which converts an analog High Frequency (HF) signal, obtained by reading the patterns of marks and spaces representing the information, into a digital information signal. Furthermore, the VFO fields are used to set the dynamic range of an Automatic Gain Controlled (AGC) amplifier which ensures that the full range of an analog-to-digital conversion circuit is utilized. A VFO field consists of a predetermined synchronization pattern of marks 31 and spaces 30.

The ID fields each comprise a pattern of marks 31 and spaces 30 representing the address of the segment. A first part of an ID field carries the track number, a second part carries the segment number, and a third part carries control information such as a number identifying the first ID field, ID1, or the second ID field, ID2, and a cyclic redundancy check (CRC) code word. Both the first ID field, ID1, and the second ID field, ID2, in a single header comprise an identical track number and an identical segment number.

The header further comprises an information field DI. This information field DI holds information describing properties of the information carrier such as, for example, the number of recording layers, the type of the recording layers, the read power, the write power, the ratio of the erase power to the write power, the ratio of the bias power to the write power, parameters used in an Optimum Power Control (OPC) procedure in a recording device, and parameters describing the shape of a sequence of write pulses generated by a recording device to record data on the information carrier.

Information fields DI may be present in all headers of an information carrier 1 or, alternatively, just in a group of headers. In the headers not comprising an information field DI, a second synchronization field VFO2 is located just before the second identification field ID2 as is shown in FIG. 3c.

An information field DI in a header has a fixed storage capacity of, for example, 288 channel bits, i.e. 15 information bytes together with 52 control channel bits. This storage capacity may be insufficient to hold all information describing properties of the information carrier. Now, the information of several information fields DI of a sub-group of headers is grouped into an information frame carrying several parameters, each parameter describing a property of the information carrier. In this way the information is distributed over a sub-group of headers.

FIG. 4 shows a disc-shaped information carrier 2 of an optically readable type according to a second embodiment of the invention. On this information carrier 2 groove tracks 22 are formed by a single spiral groove extending from the inside of the information carrier towards the outside of the information carrier. Each track is divided into 8 segments numbered segment0 to segment7. Each segment starts with a header. The information contained in the information fields DI in the headers of 16 consecutive headers 101 to 108 (that is, the headers in a first track 22) and 201 to 208 (that is, de headers in a second consecutive track 22) is grouped together into a single information frame. In this way the information frame has a storage capacity of 240 information bytes, i.e. 2 tracks times 8 segments times 15 information bytes/segment. The information in a single information frame may be protected by an error correction code such as, for example, a Reed-Solomon code.

The disc-shaped information carriers of an optically readable type are shown by way of example only. Moreover, the invention is not limited to optically readable information carriers. Alternatively, the invention may also be applied to, for example, magnetically or magneto-optically readable information carriers. It should also be noted that the storage capacity of the fields in the headers is given merely by way of example. Other capacities may alternatively be employed.

FIG. 5 shows a reading device according to the invention for reading the disc-shaped information carrier 1 of an optically readable type. The reading device comprises reading means 45 for reading information, such as the information in the synchronization field VFO1, the identification fields ID1 and ID2 and the information field DI, from the information carrier 1. The reading means 45 scan the tracks 22, 23 by way of a radiation beam 46. The radiation beam is generated by, for example, a diode laser located in the reading means 45. The information carrier 1 rotates, driven by driving means, while the reading means 45 read the tracks 22, 23 by way of the beam 46 and convert the optically readable marks representing the information into an electric signal 47. The reading device also comprises decoding means 50 for converting the electric signal 47 into a digital information signal 48 and control means 55.

The information describing properties of the information carrier 1, stored in the information fields DI, is read by the reading means 45 and converted into a digital information signal 48 by the decoding means 50. Control means 55 extract from this digital information signal 48 the individual parameters, each parameter describing a property of the information carrier 1. Such a parameter is, for example, the optimum read power for reading information from the information carrier 1. In dependence on the value of this parameter specifying the optimum read power, the control means 55 generate a control signal 49 controlling the read power in the reading means 45.

It should be noted that the above-mentioned embodiments illustrate rather than limit the invention, and that those skilled in the art will be able to design many alternative embodiments without departing from the scope of the appended claims. In the claims, any reference sign placed between parentheses shall not be construed as limiting the claim. The word “comprise” and its conjugations does not exclude the presence of elements or steps other than those listed in the claims.

1. An information carrier comprising an information area for recording data encoded in marks, said information area comprising tracks provided with a servopattern comprising headers alternating with track portions, which headers comprise a synchronization field comprising marks representing a predetermined synchronization pattern for synchronizing a clock frequency in a device the information carrier is used in, a first identification field comprising marks representing position information, and subsequently a second identification field comprising marks representing position information,
characterized in that
the headers in at least a group of headers also comprise an information field located in between the first identification field and the second identification field, said information field comprising marks representing information.

2. An information carrier as claimed in claim 1,
characterized in that
the information field comprises marks representing information describing properties of the information carrier.

3. An information carrier as claimed in claim 1 or 2,
characterized in that
the headers in a second group of headers also comprise a second synchronization field located in between the first identification field and the second identification field, said second synchronization field comprising marks representing a predetermined synchronization pattern for synchronizing a clock frequency in a device the information carrier is used in.

4. An information carrier as claimed in claim 3, the information area comprising a lead-in zone comprising marks representing control information, a data zone intended for recording user data, and a lead-out zone comprising marks representing control information,
characterized in that
the headers in data zone comprise a second synchronization field located in between the first identification field and the second identification field, said second synchronization field comprising marks representing a predetermined synchronization pattern for synchronizing a clock frequency in a device the information carrier is used in.

5. An information carrier as claimed in claim 1 or 2,
characterized in that
the information is distributed over a sub-group of headers.

6. An information carrier as claimed in claim 5, characterized in that the information is distributed over a predetermined number of consecutive headers.

7. An information carrier as claimed in claim 5, characterized in that the information is coded by means of an error correction code prior to distributing the information over the sub-group of headers.

8. An information carrier as claimed in any of the claims 1 to 6, characterized in that the recording area comprises recorded data.

9. An information carrier as claimed in claim 8, characterized in that the information carrier is of a read-only type.

10. A reading device for reading data from an information carrier comprising an information area for recording data encoded in marks, said information area comprising tracks provided with a servopattern comprising headers alternating with track portions, which headers comprise a synchronization field comprising marks representing a predetermined synchronization pattern for synchronizing a clock frequency in a device the information carrier is used in, a first identification field comprising marks representing position information, and subsequently a second identification field comprising marks representing position information, which device comprises reading means for retrieving data from the information carrier,
characterized in that
the reading means are arranged for retrieving information describing properties of the information carrier from an information field located in between the first identification field and the second identification field in the headers,
and in that the reading means are set in dependence on the retrieved information describing properties of the information carrier.

11. A recording device for recording data on an information carrier comprising an information area for recording data encoded in marks, said information area comprising tracks provided with a servopattern comprising headers alternating with track portions, which headers comprise a synchronization field comprising marks representing a predetermined synchronization pattern for synchronizing a clock frequency in a device the information carrier is used in, a first identification field comprising marks representing position information, and subsequently a second identification field comprising marks representing position information, which device comprises reading means for retrieving data from the information carrier and recording means for recording data on the information carrier,
characterized in that
the reading means are arranged for retrieving information describing properties of the information carrier from an information field located in between the first identification field and the second identification field in the headers,
and in that the recording means are set in dependence on the retrieved information describing properties of the information carrier.
